(19) United States
(12) Patent Application Publication
(10) Pub. No.: US 2014/0159509 A1
(43) Pub. Date: Jun. 12, 2014

(54) Battery Boost Jump Starter

(71) Applicant: Mathew Inskeep, Boca Raton, FL (US)

(72) Inventor: Mathew Inskeep, Boca Raton, FL (US)

(21) Appl. No.: 13/972,131

(22) Filed: Aug. 21, 2013

Related U.S. Application Data
(60) Provisional application No. 61/699,596, filed on Sep. 11, 2012.

(51) Int. Cl. H02J 7/00

(52) U.S. Cl. CPC H02J 7/0063
USPC 307/150

(57) ABSTRACT

A portable battery boost and jump starter apparatus for charging a vehicle battery is described. The apparatus can monitor and determine the existence of a fault condition in the vehicle battery and provide a battery boost or jump start depending on the level of depletion.

This application claims the benefit and priority of U.S. Ser. No. 61/699,596

### STATEMENT REGARDING FEDERALLY SPONSORED RESEARCH

The invention was not made under government contract, nor was federal grant money used to fund the research.

### FIELD

Portable twelve volt automotive battery jumper pack with built-in booster.

### BACKGROUND

Nearly all land vehicles, including but not limited to automobiles include a battery to support storage of power to run the vehicle. This is usually in the form of a lead acid battery wired to the engine structure of the automobile. Automobile batteries are typically drained of power when the lights are left on or some other load is left to draw power from the battery without the motor turning the alternator. The vehicle owner is often left with the option to enlist a stranger to ‘jump start’ his depleted battery by attaching cables from the depleted battery to the stranger's automobile battery to start the motor. The present invention is a battery boost apparatus that can charge a vehicle as well as jump start the vehicle in cases of battery power depletion. The invention enables the user to boost charge or jump start the vehicle without the assistance of another person and their vehicle.

### SUMMARY

The disclosure relates to a portable battery boost apparatus that detects the existence of a fault condition relating to the charging of the vehicle battery combined with a battery powered vehicle jump starter. An objective of the invention is to provide an apparatus with self contained, internal, rechargeable battery comprised of either a lithium ion battery, other type of battery or a sealed lead acid battery to boost charge or jump start depending on the circumstances.

The present invention relates generally to a portable twelve volt automotive battery jumper pack and in particularly to a combination of an integrated built-in booster, capable of recharging a depleted automotive battery through the accessory socket of a vehicle, thereby providing an electrical connection between the portable twelve volt automotive battery jumper pack with built-in booster and a vehicle battery. Conventional portable battery booster which do not include a built-in booster circuit, require a direct connection to a vehicle battery in order to provide a transfer of energy on demand, with the added feature of a built-in booster circuit, the portable twelve volt automotive battery jumper pack with built-in booster does not require a direct connection to the battery, but instead, uses the internal wiring system of a particular vehicle to transfer the energy on demand to the vehicles battery.

### DRAWINGS

The features and advantages of the invention will be apparent from the following drawings and like reference numbers.

FIG. 1 is a wiring diagram of the portable twelve volt automotive battery jumper pack with built-in booster according to an embodiment of the invention.

FIG. 2 is a flow chart of the operations of the portable twelve volt automotive battery jumper pack with built-in booster according to an embodiment of the invention.

FIG. 3 is a block diagram of the internal operations of the portable twelve volt automotive battery jumper pack with built-in booster according to an embodiment of the invention.

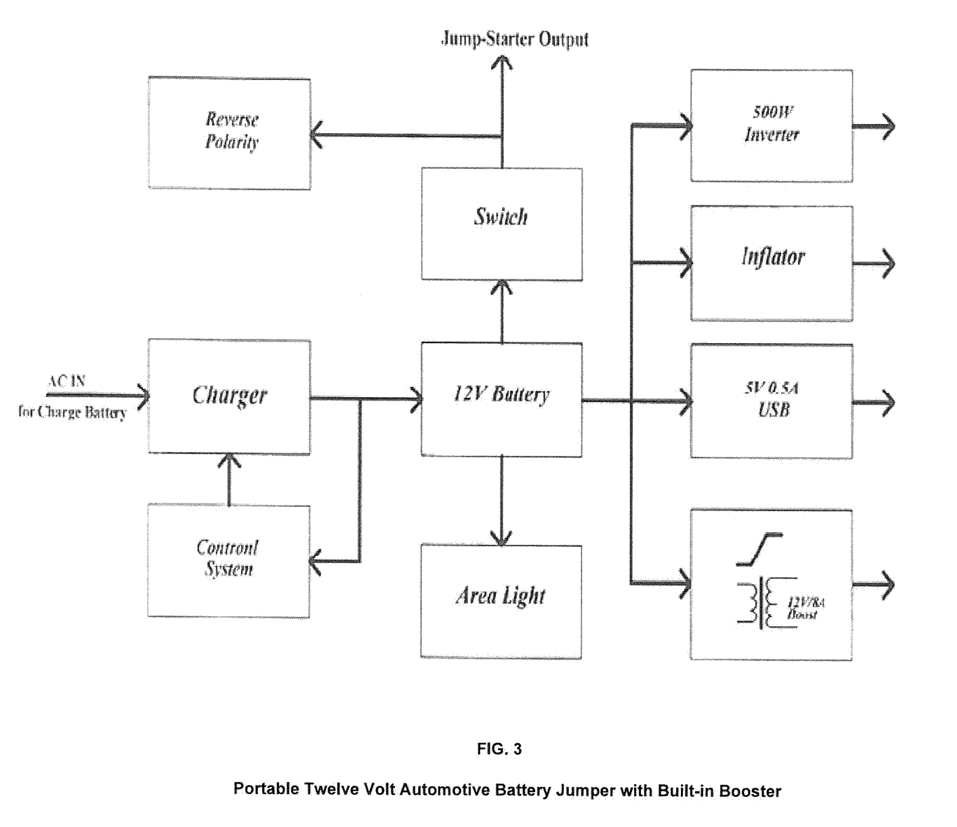

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant will recognize that other equivalent parts can be employed and other methods developed without the departing from the general spirit and scope of the invention.

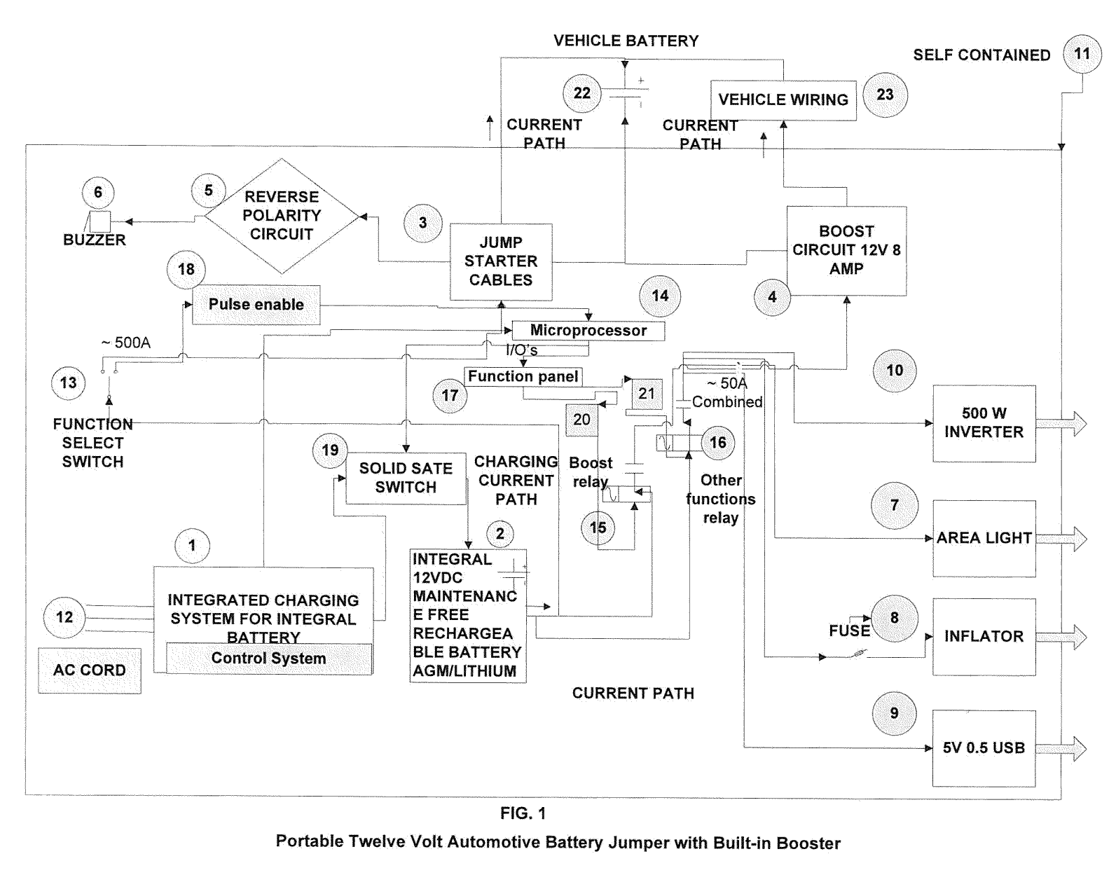

Referring now to the drawings, FIG. 1, will be understood to be a complete portable twelve volt automotive battery jumper pack with built-in booster, including internal components and embodiment housing 11. FIG. 1 depicts the internal components of the described portable twelve volt automotive battery jumper pack with built-in booster. The apparatus is a self-contained structure 11 (FIG. 1) including an integrated three conductor shielded cord 12, which main purpose will be to recharge the integral host battery 2 via household type receptacles, which the purpose of the integral battery 2 will be to couple with a twelve volt battery 22 or a vehicle's electrical system 23 via jump starter cables and clamp 3, and an alternative option will be to utilize the claimed boost circuit 4 through the vehicle's electrical system in order to efficiently replenish the energy of the twelve volt battery 22 in case of depletion and or loss of energy. The integral battery 2 ideally must be fully charge via three conductor shielded cord 12, which is directly coupled to the integrated charging system 1. The integrated charging system is a high frequency charger with its own internal multi-stage control system that will provide the charging means to the integral battery 2, by electronically biasing the solid state switch 19. It should be noted that the integral battery contained within this system, might be on occasions of various other battery chemistry (such as lithium ion), sizes, shapes, in order to accommodate various scenarios that could demand alternative power options due to environmental needs.

The integral battery 2 has three possible paths for energy to flow out and into various integral component within the self-contained embodiment 11. Refocusing to the claim of an integral boost circuit 4, is a high frequency charging system which is configured to recharge a depleted battery. This high frequency charging system's main source of energy is the integral battery 2. This portable twelve volt automotive battery jumper pack with built-in booster has a main user function select mechanical switch 13. The function select mechanical switch 13, engages the jump starter capability 3 when turned to one direction, and it engages all other built in functions when turned to the opposite direction. This other built in functions will be referred to as a five hundred watt inverter 10, area light 7, inflator 8, universal serial bus 9 and the boost circuit 4. In order to access the boost circuit 4, the function select mechanical switch must initially be in the other built in functions position. Once in this mode, an enable pulse is sent to the microprocessor 14 enabling the function panel 17. The user can then select the boost circuit 4 by depressing the function switch 20 on the function panel 17. Once the function switch 20 is depressed, a signal is sent to the electromechanical boost relay 15. The electromechanical boost relay 15 coils become energized, causing the high current contacts to closed, allowing the energy to flow between the integral battery 2 into the boost circuit 4 and finally into the vehicle wiring system 23 and into the twelve volt depleted automotive battery 22. The boost circuit 4 will connect to the vehicles wiring system 23 by using a cigarette lighter plug.

A secondary function of this portable twelve volt automotive battery jumper pack with built-in booster couples with a twelve volt depleted automotive battery 22, is by user selectable function select mechanical switch 13. This particular mechanical switch 13 is of high current capability specifically designed to carry sufficient energy between the integral battery 2 and the vehicle battery 22 when energy is required. It should be noted that this particular mechanical switch 13 contained within this system, might be on occasions replaced by a solid state switch in order to accommodate various scenarios that could possibly demand alternative options due to environmental needs.

The jump starter 3 function circuit does have a buzzer 6 which is activated when the jump starter cables 3 are connected in the opposite voltage potential to that of the vehicle battery 22 and the host battery 2, thus creating a fault condition best known in the industry as reverse polarity. A description of the cables and clamps within the jump starter cables 3 is found in numerous other prior arts and will only be discussed briefly as the size of the jump starter cables 3 are #4AWG, and can be four feet in length. The described jump starter cables contained color-coded alligator clips red (+) and black (−) and they are to be directly connected to depleted battery according to proper polarity. The alligator clips can accommodate vehicle batteries with top or side terminal posts. The color-coded alligator clips are made of copper material for maximum energy transfer. The colors represent the proper polarity to be connected to the vehicle system by user.

The third and final function is activated via the microprocessor 14. The user can depress function switch 21 enabling the other functions relay 16. Similarly to that of the boost relay 15, once the function switch 21 is depressed a signal is send to the electromechanical boost relay 16. The electromechanical boost relay 16 coils becomes energized, causing the high current contacts to close, allowing the energy to flow between the integral battery 2 into the remaining functions described as the five hundred watt inverter 10, area light 7, inflator 8 and universal serial bus 9.

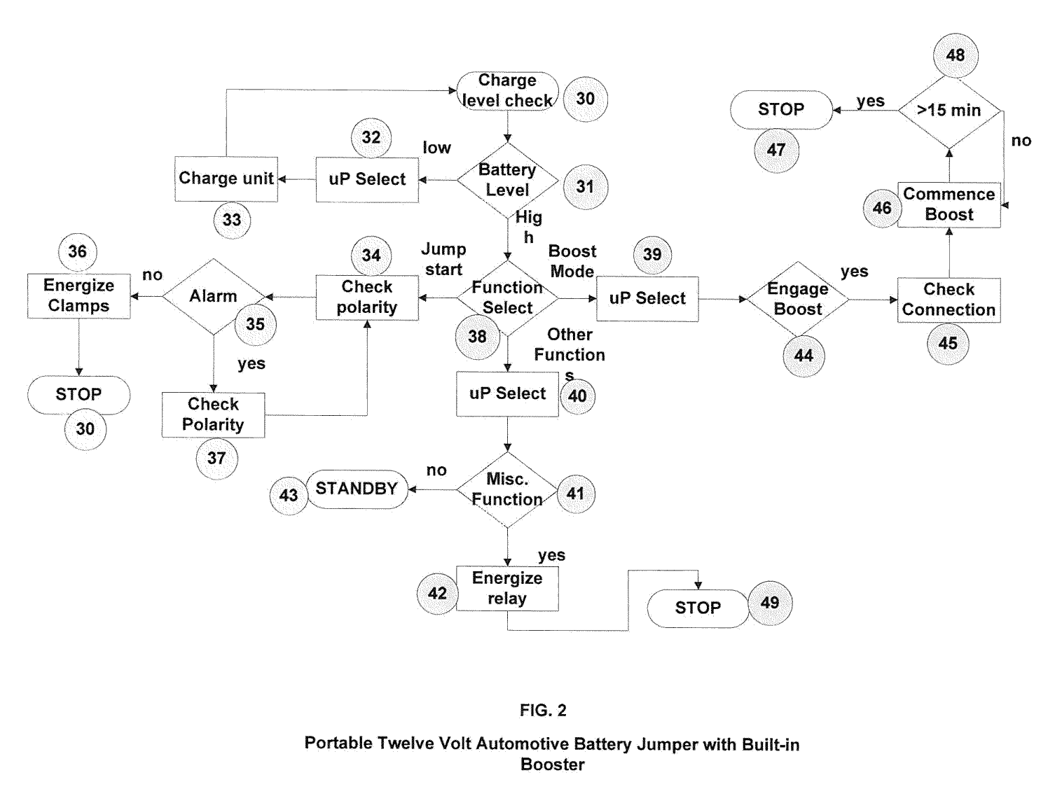

Referring now to FIG. 2 as supporting document to FIG. 1, the depicted flow chart of the operations of the portable twelve volt automotive battery jumper pack with built-in booster will describe the previously described functions built into the jumper pack, focusing on the claims; a battery jumper with integrated booster. First, the functionality of the invention depends on the initial charge level 30 of the battery jumper pack, when the user checks the charge level 30, the battery level indicator 31 will indicate that the integral battery FIG. 1, 2, has enough energy by showing high or low charge indication. The system integral microprocessor FIG. 1 14 will guide the user to charge the unit 32 until it is ready to use or if the battery level 31, shows that the integral battery FIG. 1 2 is high, the user will be able to continue and select other functions, by using the function panel FIG. 1 17 as previously described in the wiring diagram.

Once in this stage, there is a three way branch called function select 38, where the user is free to select between the integral function in the self-contained embodiment FIG. 1 11. First, focusing in the two claims of jump starter FIG. 1, 3 and boost circuit FIG. 1 4, initially directing our attention to the jump starter FIG. 1, 3, if this option is selected, the circuit will initially check for proper connection to the vehicle battery FIG. 1, 22 via check polarity circuit 34. If the proper connection was achieved no alarm 35 will sound and the user will be able to energize the clamps function select switch FIG. 1, 13, otherwise the check polarity alarm 35 will sound audible indicating there is a fault condition on the connection, guiding user to double check the connection until proper connection is achieved between the integral battery FIG. 1, 2 and the vehicle battery FIG. 1, 22. Next, the acceptable branch function select 38 can also enable the boost mode to be selected. The microprocessor FIG. 1, 14 will enable the user to boost select 39, and engage the boost circuit 44, The boost circuit will check for a proper connection 45 and commence boost mode 46 for a period for at least fifteen minutes 48, before indicating the vehicle battery FIG. 1, 22 is ready to use. The last branch of the function select 38 is access to the miscellaneous functions 41. The miscellaneous functions are described on FIG. 1 as a five hundred watt inverter FIG. 1, 10. This function is typically used to power small electronic equipment in case of a power outage or where no main electricity is available. The area light FIG. 1, 7, can light small dark areas via low power light emitting diodes. The inflator FIG. 1, 8, can be used to inflate automotive tires in case of a flat tire and lastly the universal serial bus FIG. 1 9, can recharge small electronics.

Additionally, as supporting document to further explain FIG. 1 and FIG. 2, there is a block diagram showing connections for all major components, explained above.

What is claimed is:

1. A portable battery boost and jump starter apparatus for charging a vehicle battery comprising:
a high frequency boost circuit charger microprocessor controlled automotive apparatus jump starter capable of boosting a vehicle battery via cigarette lighter outlet using integrated boost circuit; and method of operating same.

2. The portable battery boost and jump starter apparatus of claim 1 with reverse polarity protection and microprocessor;

3. The portable battery boost and jump starter apparatus of claim 1 with fault circuitry and indicator alarm buzzer;

4. The portable battery boost and jump starter apparatus of claim 1 with integrated power inverter, area light, inflator and USB port.
